(19) United States
(12) Patent Application Publication
(10) Pub. No.: US 2003/0046822 A2
(43) Pub. Date: Mar. 13, 2003

(54) MEASURING TOOL AND ADJUSTING TOOL FOR AMMUNITION

(76) Inventor: Heinz BERGER, Heimenschwand (CH)

Correspondence Address: FOLEY &, LARDNER, One IBM Plaza, 330 North Wabash Avenue, Suite 3300, Chicago, Illinois, 60611-3608, US, (312) 755-1900, (312) 755-1925

(21) Appl. No.: 10/158,043

(22) Filed: May 28, 2002

(30) Foreign Application Priority Data
Jun. 1, 2001 (CH) CH 2001 1006/01

(51) Int. Cl. G01B 5/00

(52) U.S. Cl. 33/506; 33/550

(57) ABSTRACT

### ABSTRACT

A measuring device for measuring the concentricity of cartridges (30, 31), more particularly rifle cartridges, is essentially composed of a main body (1) provided with chambers (2) for cartridges of one or a plurality of calibers. The cartridges are radially retained in the chambers by so-called diameter compensators (9) but rotatable about their longitudinal axis. In the area of the point (39) of the projectile, an access for a measuring means (3) is provided, e.g. a dial gauge, the latter indicating the deviation of the projectile from perfect concentricity by the magnitude of its deflection variation when the cartridge (30, 31) is rotated. An aligning device (4) that is preferably also provided allows to exert a lateral pressure on the projectile in order to obtain an improved concentricity.

### FIELD OF THE INVENTION

The invention refers to a device for measuring the concentricity of a projectile with respect to the case body of a cartridge, more particularly of a rifle cartridge.

According to the latest findings confirmed by bench rest firing tests, an eccentricity of the projectile with respect to the case exceeding 0.025 mm will cause a deterioration of the firing precision that increases with the eccentricity. In this context, the eccentricity is defined as the angle between the longitudinal axis of the projectile and the case. Ideally, i.e. in the case of perfect concentricity, this angle is equal to zero.

### BACKGROUND OF THE INVENTION

The reduced precision resulting from the eccentricity not only affects the marksman in bench rest shooting. On the contrary, the various types of ammunition, all those applications are concerned where an absolute precision is an indispensable condition for the marksman, such as precision sports shooting, especially medium or long distance, as well as applications in public or private security or in hunting.

Known apparatus for controlling and correcting the concentricity of a cartridge, i.e. essentially for aligning the projectile with respect to the case, only allow a rudimentary concentricity control and do not take account of the actual position of the cartridge in the cartridge chamber of a firearm.

### SUMMARY OF THE INVENTION

It is an object of the invention to provide a device allowing the measurement and preferably also the alignment of the projectile of a cartridge in order to achieve an improved firing accuracy.

This is accomplished by a device wherein said device comprises a main body having at least one chamber for the cartridge, said chamber includes means for retaining said cartridge by pressing it against a wall of said chamber such that said cartridge remains rotatable, and an access is provided through which a measuring means is capable of contacting the projectile of said cartridge, such that the concentricity of said projectile with respect to said case body is measurable in rotating of said cartridge. Preferred embodiments are described in the remaining claims.

Accordingly, the device essentially imitates the positioning of a rifle cartridge in the cartridge chamber in order to detect concentricity errors of the projectile of the cartridge with respect to its case. In a preferred embodiment, excessive concentricity errors can be corrected by a correcting device.

According to a preferred embodiment, the device is small and inexpensive in manufacture, thus making it suitable for universal applications and easy transport by the marksman. Most preferably the device is in the form of a hand-held tool.

Other preferred embodiments are defined in the claims.

### BRIEF DESCRIPTION OF THE DRAWINGS

The invention will be further explained by way of example with reference to a preferred embodiment illustrated in the figures.

FIG. 1 shows the main body of a device according to the invention in a longitudinal section.

FIG. 2 shows a top view of the device of FIG. 1.

FIG. 3 shows a side view of an improved aligning point.

FIG. 4 shows a view of the push piece according to arrow 51 in FIG. 3 and.

FIG. 5-7 shows target diagrams.

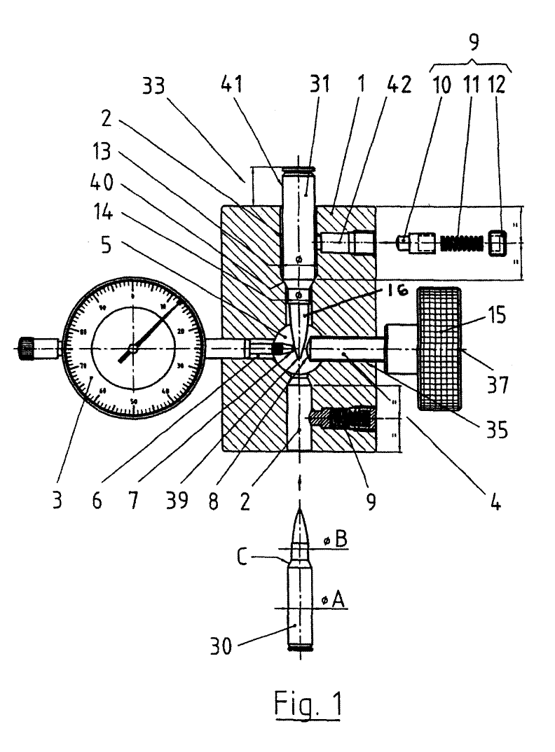

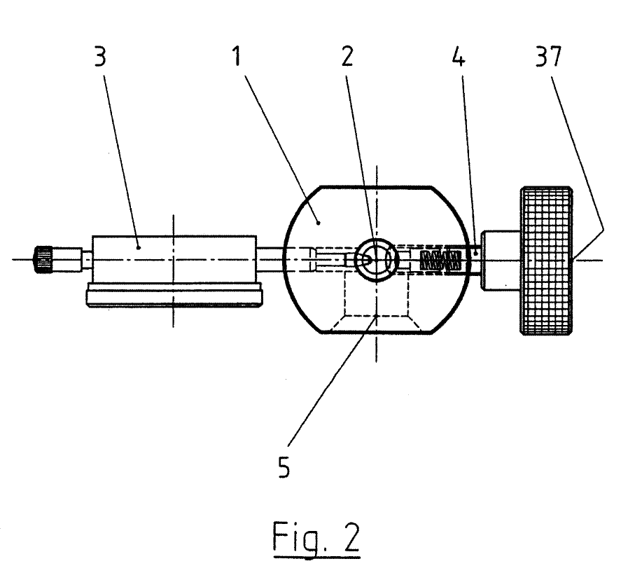

### DETAILED DESCRIPTION OF THE PREFERRED EMBODIMENTS

The cylindrical main body 1 of the device is preferably made of a shock-resistant plastics material having good sliding properties. Two cartridge chamber imitations 2 of different calibers are provided in the main body in the form of central longitudinal bores.

The cartridge chamber imitations 2 are so designed that cartridges 30 (smaller caliber) and 31 (larger caliber) inserted for concentricity control and adjustment project from the front sides of the main body 1 by a distance 33 that allows the manual rotation of the cartridges 30, 31 required for measuring and adjusting purposes.

A location bore 6 for a commercially available dial gauge 3 is provided in the main body 1 and extends transversally to the cartridge chamber imitations 2. Due to a close fit, the dial gauge 3 is self-adhesive in the location bore 6 but freely displaceable and freely rotatable in order to allow optimum readability. Aligning device 4 includes a threaded bore 35 intended for aligning screw 37 is disposed coaxially opposite the location bore 6 of the dial gauge 3, the aligning screw 37 essentially consisting of handle portion 15 and a threaded spindle.

The position of the dial gauge 3 and of the aligning screw 37 in the main body 1 is such that the inserted cartridge 31 can be measured (measuring point 7 of the dial gauge 3) and aligned (spindle point 8) in the area of projectile point 39.

In the context of the present invention, the difference between the minimum and the maximum reading of the dial gauge 3 during rotation of the cartridge 30, 31 will be used as a measure of the concentricity error. Since the dial gauge 3 measures the excursion of projectile 16 near its point, this value is approximately equal to the diameter of the circle described by the projectile point 39 during rotation of the cartridge 30, 31 around the longitudinal axis of the case.

In order to compensate for existing differences in the diameters of the cartridge 30, 31, the cartridge chamber imitations 2 in the main body 1 are designed with larger diameters than the respective cartridge, namely 1 to 2% larger than the theoretical case body diameter in area 13 of case body A and approx. 10% larger than theoretical case neck diameter B in area 14. Throat 40, located between areas 13 and 14, serves as a rest for cartridge shoulder C and thus as a stop when inserting the cartridge 30, 31 in the cartridge chamber imitation 2.

By means of diameter compensators provided in the main body 1 on the side of the aligning screw 37 and in the center of the cartridge chamber imitations 2, and composed of end cap 12, spring 11, and sliding piece 10, the cartridges 30, 31 are maintained in the chambers 2 in such a manner that the cartridges 30, 31 are manually rotatable in the cartridge chamber imitations 2 under an even and adjustable tension. Stepped bores 42 for compensators 9 are preferably provided on the side of the aligning screw 37 between the respective rear end of the cartridge chamber imitation 2 and the throat 40.

An opening, in the present example in the form of a blind bore 5, extending towards the center of the main body 1 and located at the same height as the bores for the dial gauge 3 and the aligning screw 37, however offset therefrom, serves as a viewing window and allows an additional, but not indispensable, visual control of the measuring and aligning operations.

Especially in the case of larger calibers, e.g. ammunition of caliber 10.3 x 60R, depending on the case structure, greater aligning forces are required. These may cause a slight deformation of the projectile 16 at the contact surface between the aligning point and the projectile 16. The resulting rotational eccentricity affects the firing precision. In particular, this may be the case with projectiles where a relatively soft core is enclosed in a think jacket.

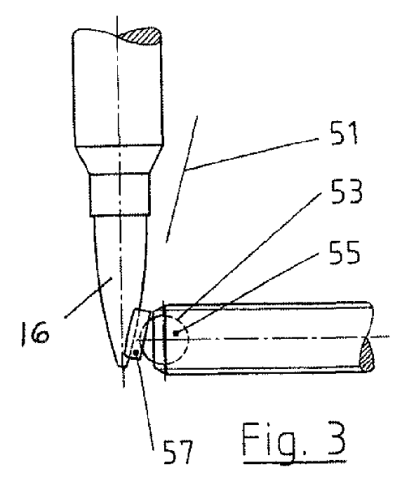

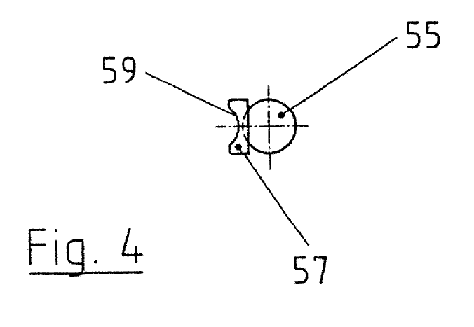

This problem is solved by the embodiment illustrated in FIGS. 3 and 4.

Aligning point 8 contains a seat 53 for a ball 55 to which a thrust plate 57 is affixed. FIG. 4 shows a projection of the ball 55 and the plate 57 according to arrow 51 (FIG. 3). It is visible that the thrust plate 57 comprises an approximately cylindrical depression 59. In particular, the depression 59 may also be precisely adapted to the surface of the projectile 16 in the contact zone.

Otherwise, the measuring and aligning device 1 corresponds to the previously described embodiment.

The thrust plate 57 thus provides an enlarged engaging surface for the transmission of the aligning force to the projectile 16. Practical tests have shown that a deformation of the projectile 16 is excluded when this thrust point is used.

A further advantage of this embodiment of the aligning point consists in that the rotational movement now occurs between the ball 55 and the seat 53 in the aligning point, whereas the point rolls on the projectile surface in the simple embodiment.

A measuring and aligning procedure will be described in the following: The aligning device allows exertion of a lateral pressure on the projectile 16 in order to improve concentricity. The cartridge 31 is inserted in the cartridge chamber imitation 2 of the corresponding caliber. The dial gauge 3 is inserted in the bore 6 until the measuring point 7 contacts the point 39 of the projectile 16. The projecting end 41 of the cartridge 31 is seized between thumb and index and rotated at least 360°, meanwhile determining the total deflection of the dial gauge 3, i.e. the difference between the minimum and the maximum reading of the measuring gauge. The cartridge 31 is further rotated until the dial gauge 3 reaches the minimum reading that corresponds to the maximum deflection of the projectile point towards the aligning point 8.

Rotation of the aligning point 8 by means of the knob 15 will result in a pressure acting on the point 39 of the projectile 16, thereby deflecting it to such an extent that the point 39 of the projectile 16 remains laterally deflected from its original position by half of the total deflection of the dial gauge 3 when the aligning point 8 is lifted off. The aligning operation is then completed.

It will further be noted that the device of the invention also allows to detect and single out cartridges whose case is deformed or damaged or whose total length excessively deviates from the ideal value due to a different setting depth.

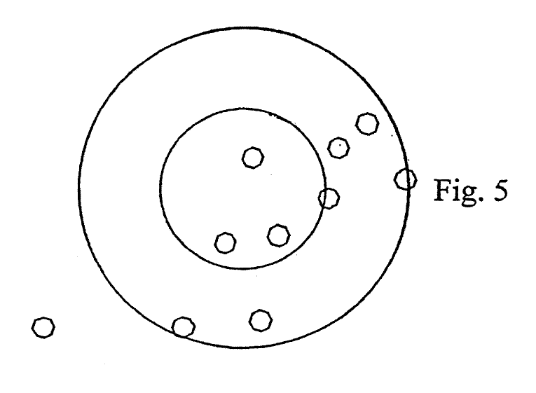

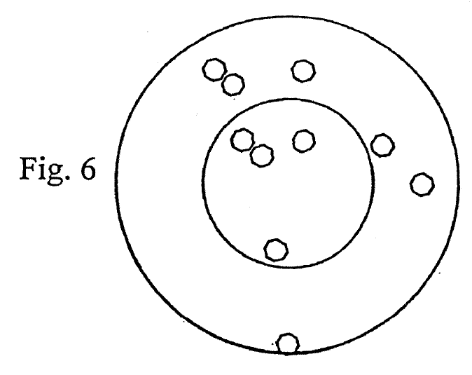

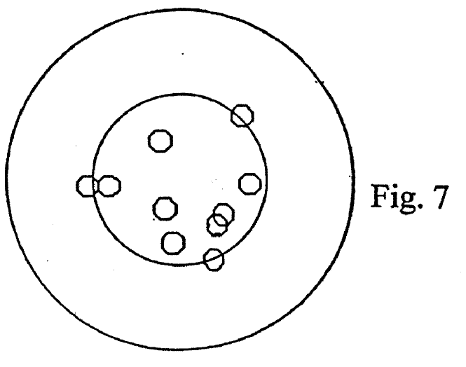

The target diagrams of FIGS. 5 to 7 illustrate the effect of the alignment of the cartridges 30, 31 by means of the device 1 of the invention. The illustrations correspond to target diagrams obtained by firing a rifle fixed in a holding device on a distance of 300 m. The inner target circle had a diameter of 50 mm. FIG. 5 shows the diagram obtained with the cartridges 30, 31 having a concentricity error of 0.1 to 0.18 mm, FIG. 6 shows the target diagram obtained with a concentricity error of less than 0.1 mm, and FIG. 7 shows the target diagram in the case of a concentricity error of no more than 0.03 mm. The comparison of FIGS. 5 and 6 already shows a noticeable concentration of the hits in the target center, while FIG. 7 shows a distinct improvement of the firing accuracy. It will be understood that a concentricity error of no more than 0.03, as in the case of the cartridges 30, 31 used for target diagram FIG. 7, can only be achieved by aligning the cartridges 30, 31 in the device 1 of the invention, while the cartridges 30, 31 having concentricity error of up to 0.1 mm may still be obtained by measuring and singling them out, for which purpose the cartridge measuring device 1 of the invention is advantageous as well.

Modifications with respect to the preceding description are accessible to those skilled in the art without departing from the scope of protection of the invention as defined by the claims. Conceivable options are e.g.

-to manufacture the main body of a material other than plastics material;

-a different shape of the main body, e.g. an essentially parallelepipedic shape;

-more than one viewing window;

-viewing windows in the form of a through-going bore, thereby allowing an observation from both sides of the tool;

-no viewing window at all;

-to provide the device with a different number of cartridge chamber imitations, particularly also only one;

-to provide the diameter compensators in a different place than in the center of the section receiving the case body or in a different position than opposite the dial gauge;

-a cross-section of the cartridge chamber imitations other than circular, e.g. a V-shaped cross-section with the point of the V opposite the compensator;

-more than one diameter compensator per cartridge chamber imitation;

-a different deviation of the cartridge chamber diameters from the nominal diameter of the cartridges;

-a cartridge chamber imitation in the form of an insert in the main body, the use of different inserts allowing the adaptation to different calibers;

-a measuring device other than a mechanical dial gauge, e.g. a gauge having a digital display and/or a signal or data output e.g. for connection to a computer controlled measuring device;

-a motor-driven form of the aligning device 4, particularly in conjunction with a measuring device having a signal or data output, thereby allowing a nearly entirely automatic operation, e.g. according to the following sequence:

Insertion of cartridge

Start of measuring operation

Rotation of cartridge by at least a full turn in order to determine concentricity error.

Stop of measuring operation, rotational positioning.

Rotation of cartridge, possibly according to instructions from the measuring and aligning device, until position of maximum deviation of projectile towards aligning device is attained.

Stop of rotational positioning, start of aligning operation.

Advance of the aligning device 4 and deflection of projectile until measuring device detects a predetermined deflection, under control of measuring and aligning device.

Verification of concentricity error essentially by repeating the measuring procedure.

Motorized device for effecting the rotation of the cartridge (preferable if the measuring and aligning device is designed for automatic operation).

WHAT IS CLAIMED IS:

1. A device for evaluating the concentricity of a projectile with respect to a case body of a cartridge holding the projectile, wherein said device comprises a main body having at least one chamber for holding and concentricity control of said cartridge, and an access passage provided through the at least one chamber, such that the concentricity of said projectile with respect to said case body can be evaluated by rotating said cartridge in said at least one chamber.

2. The device of claim 1, further including means for retaining said cartridge by pressing it against a wall of said chamber such that said cartridge remains rotatable in said chamber.

3. The device of claim 1, wherein said access passage comprises a bore through which the measuring point of a dial gauge contacts said projectile.

4. The device of claim 1, wherein said means for retaining allows pressing a cartridge against a wall section of the at least one chamber in order to provide a reproducible measurement of the concentricity.

5. The device of claim 4, wherein said means for retaining comprises a head portion capable of being pressed into a body against an elastic return force and which in its inactive position projects into said at least one chamber to such an extent that it is pressed in by the case body of the cartridge inserted in said at least one chamber, the resulting return force causing the radial retention of the cartridge in said at least one chamber.

6. The device of claim 1, wherein at least said one chamber and the entire main body comprise a material having a low friction against the cartridge , in order to provide an easy rotation ability of said at least one cartridge in said chamber.

7. The device of claim 1, further comprising an aligning device to exert a lateral pressure on the projectile of the cartridge inserted in said at least one chamber, thereby allowing said projectile to be aligned with respect to the case body.

8. The device of claim 7, wherein said aligning device comprises an aligning point capable of being pressed against the projectile of the cartridge inserted in said at least one chamber by actuating an operating means.

9. The device of claim 8, wherein said aligning device comprises a shank that is rotatably disposed in a thread of said main case body and whose end is provided with said aligning point such that said aligning point is axially movable by rotating a shaft.

10. The device of claim 7, wherein said access is located such that the contact zone of said measuring means is substantially opposed to the contact zone of said aligning device on the projectile.

11. The device of claim 1, wherein said main body comprises a window allowing a visual observation of at least one of the projectile of the cartridge inserted in said at least one chamber.

12. The device of claim 1, wherein said at least one chamber comprises a throat and the cartridge case includes a shoulder and such that the position of said cartridge in the longitudinal direction of said at least one chamber is determined by abutment of the shoulder of an outside portion of the cartridge when inserting the cartridge.

13. The device of claim 1, wherein said main body comprises a plurality of said at least one chamber for the cartridge, the plurality of at least one chamber being of different calibers.

14. The device of claim 13, wherein at least two of said at least one chamber are located such that the projectile of the cartridge inserted therein in each of the at least one chamber is in the correct position for carrying out a measurement for an alignment by said aligning.

15. The devise of claim 1 further including measuring means for contacting the projectile of said cartridge to measure the concentricity of said projectile.

16. A device for measuring the concentricity of a projectile with respect to a case body of a cartridge comprising:
a main body of the device for holding a cartridge;
an access port in the main body; and
measuring means disposed through the access port and contacting the projectile of the cartridge, thereby enabling concentricity of the projectile to be measured relative to the case body of the cartridge during rotation of the cartridge.

17. The device as defined in Claim 16 further including means for retaining the cartridge that presses against the cartridge which remains rotatable within the main body.

18. The device as defined in Claim 16 wherein the cartridge is disposed in a substantially cylindrically shaped chamber of the main body while the concentricity of the projectile is being measured.

19. A device for rotatably retaining a cartridge holding a projectile being measured with respect to a case body of the cartridge, comprising:
a main body of the device holding a cartridge and coupled projectile with both being disposed substantially within the main body;
an access port in the main body; and
means for retaining the cartridge within the main body by pressing the cartridge against an interior chamber wall of the main body such that the cartridge rotates during measuring concentricity of the projectile relative to the cartridge.

20. The device as defined in Claim 19 further including;
measuring means disposed through the access port and contacting the projectile of the cartridge, thereby enabling concentricity of the projectile to be measured relative to the cartridge during rotation.

21. The device as defined in Claim 19 wherein the main body includes at least one substantially cylindrical chamber for receiving the cartridge and coupled projectile, the cylindrical chamber comprising the interior chamber wall.

22. The device as defined in Claim 21 wherein the main body further includes a throat portion coupled to the substantially cylindrical chamber for positioning the cartridge within the main body.

23. A device for adjusting the concentricity of a projectile with respect to a case body of a cartridge holding the projectile, comprising:
2 of claim 19 and heaving at least one chamber for receiving the cartridge;
3d of claim 19;
an aligning device to exert a lateral pressure on the projectile of the cartridge inserted in said at least one chamber, thereby obtaining substantial concentricity of the projectile relative to the case body.
